(19) United States
(12) Patent Application Publication
(10) Pub. No.: US 2014/0330621 A1
(43) Pub. Date: Nov. 6, 2014

(54) CMS STARS RATING DATA MANAGEMENT

(71) Applicant: Optum, Inc., Minnetonka, MN (US)

(72) Inventors: Matt Nichols, Buffalo, MN (US); Terrence Ward, Malverne, NY (US); Paul Claseman, St. Louis Park, MN (US)

(21) Appl. No.: 13/875,516

(22) Filed: May 2, 2013

(51) Int. Cl. G06Q 10/06; G06Q 50/26

(52) U.S. Cl. CPC G06Q 10/06393; G06Q 40/08; G06Q 50/26
USPC 705/7.39

(57) ABSTRACT

A computer-based method for managing CMS (Centers for Medicare and Medicaid Services) Stars program data includes storing historical CMS raw scores and Stars ratings in a database, which is in communication with a computer system having a user interface. The database is updated with CMS measurement data (or Stars rating data) for an insurance program, for example a Medicare Advantage Part C or Part D insurance plan or contract. The computer system is used to calculate CMS raw scores for the insurance program, based on the updated CMS Stars rating data. CMS Stars ratings are modeled and output to the user interface, based on the calculated raw scores.

### BACKGROUND

This disclosure relates generally to data management and tracking techniques, and specifically to management and tracking of health care data related to the CMS (Centers for Medicare and Medicaid Services) five-star rating system for Medicare Advantage plans (CMS Stars). In particular, this disclosure relates to proactive data management and performance tracking for CMS Stars measures, including action plan management and target setting to achieve ratings goals.

The CMS Stars rating system is based on more than fifty different quality measures, as applied to insurance plans for Medicare Part C (Medicare Advantage, formerly Medicare Choice) and Medicare Part D (MA-PD or MAPD), with prescription drug benefits. This is a five-star, contract-level rating system, in which five stars represent excellent performance, four stars represent above average performance, three stars represent average performance, two stars represent below average performance, and one star represents poor performance.

Individual CMS measures are selected from a range of different rating systems, including, but not limited to, the Healthcare Effectiveness Data and Information Set (HEDIS), developed by the National Committee for Quality Insurance (NCQA); the Consumer Assessment of Healthcare Providers and Systems (CAHPS), overseen by the overseen by the Agency for Healthcare Research and Quality (AHRQ); patient-reported Health Outcomes Survey (HOS) data, administered by the National Committee for Quality Insurance under direction of the Centers for Medicare and Medicaid Services, and other CMS or independent reviewer data.

The CMS Stars measures are selected to rate Medicare Advantage programs according to a number of different domains, for example staying healthy (screenings, tests, and vaccines), managing chronic conditions, responsiveness and care ratings, member complaints and appeals, and customer service. Drug plan measures may also be included, for example drug pricing, patient safety, customer service, member experience, and drug plan-related complaints and audit results.

The CMS Stars rating system is intended to provide better health care to individual patients and plan members, while increasing administrative efficiency, reducing provider costs, and improving overall health care outcomes, not just for Medicare participants, but as a model for the population as a whole. Final CMS Stars ratings are made available to consumers, in order to help eligible individuals select an insurance program. The ratings are also tied to reimbursement rates, and high-performing plans may qualify for bonus payments, based on contract-level performance. Ultimately, the CMS Stars program is designed to reward good health care outcomes and plan efficiency, with the combined goals of increasing the overall health of the population, while reducing total care costs.

In order to achieve these advantages, the CMS Stars program must constantly evolve to reflect current best practices. Thus, the particular Stars measures, domains, and agencies described above are merely representative. Over time, different domain and assessment categories may also be defined, along with a range of new and different individual CMS measures. Based on historical data, moreover, the various rating programs themselves are also subject to change, and different governmental agencies and non-governmental organizations (NGOs) may be designated to administer them.

Successful management and tracking of healthcare data related to CMS Stars ratings thus presents a number of different technical challenges and corresponding design considerations. In particular, highly intelligent and proactive data monitoring and analysis techniques are required, in order to set better targets for improved action plan management, provide better health care outcomes to individual plan members, and achieve desired CMS Stars rating goals.

### SUMMARY OF THE INVENTION

This disclosure is directed to computer-based systems and methods for managing CMS (Centers for Medicare and Medicaid Services) Stars program data. In exemplary applications, historical CMS measures and Stars ratings data are stored in a database. The database is provided in communication with a computer processor and user interface, for example in a server-based computing system.

The database is updated with CMS measurement data for an insurance program, for example a Medicare Advantage Part C or Part D insurance plan or contract. The computer system is configured to estimate current CMS measures for the insurance program, based on the updated CMS measurement data. The computer system also models the CMS Stars ratings, based on the estimated measures, and may predict future values as well. Model results can be output to the user interface, for interactive access by users in a Medicare payer organization.

### BRIEF DESCRIPTION OF THE DRAWINGS

FIG. 1 is a block diagram of a representative computer-based data management and analysis platform for CMS Stars rating data.

FIG. 2 is a block diagram of a representative computer-based method for management and analysis of data related to the CMS Stars rating program.

FIG. 3A is a schematic diagram of a representative authentication data structure for a CMS Stars management system.

FIG. 3B is a schematic diagram of a representative enrollment data structure for a CMS Stars management system.

FIG. 4A is a schematic diagram of a representative HEDIS data structure for a CMS Stars management system.

FIG. 4B is a schematic diagram of a representative measurement level data structure for a CMS Stars management system.

FIG. 5A is a schematic diagram of a representative domain level data structure for a CMS Stars management system.

FIG. 5B is a schematic diagram of a representative part level data structure for a CMS Stars management system.

FIG. 5C is a schematic diagram of a representative contract level data structure for a CMS Stars management system.

FIG. 6 is a schematic illustration of a CMS Stars data management and analysis system.

FIG. 7 is a representative application flow diagram for operation of the CMS Stars data management and analysis system.

FIG. 8 is a schematic illustration of a representative CMS measure interface for the CMS Stars management system.

FIG. 9 is a schematic illustration of a representative dashboard-type user interface for the CMS Stars management system.

FIG. 10 is a schematic illustration of a modeling interface for the CMS Stars management system, illustrating additional user features.

### DETAILED DESCRIPTION

This disclosure relates to data management and tracking of health care data, as directed to the CMS Stars rating program. In particular, this disclosure describes computer-implemented systems and methods for proactive CMS Stars data management and performance tracking. These techniques provide for improved action plan management and target setting, in order to improve health care outcomes and plan efficiency, and achieve corresponding CMS Stars ratings goals.

Generally, Medicare Advantage insurance plan administrators require timely, useful and actionable data in order to effectively manage their CMS Stars ratings. Historically, however, some plans have relied on annualized data that is inherently at least one to two years old, and may not be tied to actionable options that provide real opportunities to improve the overall quality of care, and achieve the corresponding CMS Stars ratings that are likely to maintain or increase membership and revenue. More generally, plan managers also require proactive data management and performance tracking strategies in order to effectively partner with the Centers for Medicare and Medicaid Services, with the ultimate goal of improving healthcare for Medicare participants.

This disclosure describes representative components of exemplary methods and systems designed to achieve these goals. These approaches provide more focused results than alternative techniques that rely on generic spreadsheets and (e.g., web-based) tabular reporting systems, and as compared to less graphical and visual systems with fewer navigable links between top-level results, mid-level priorities, and detailed, actionable opportunities. The solutions described herein also provide more effective modeling, benchmarking, trending and forecasting features, which can enable plan managers and other users to set attainable goals, prioritize initiatives, and reach achievable targets for healthcare quality and corresponding Stars ratings.

Particular features designed to help Medicare payers and other users achieve these goals include, but are not limited to:
(1) Dashboard-based graphical user interface systems, with visual navigation capability.
(2) Modeling techniques providing “what-if” scenarios for predicting overall health plan performance, and setting corresponding ratings goals.
(3) Program management components configured to assign accountable ownership of CMS measures, and to assign and track corresponding initiatives and status updates by the assigned owners.
(4) Performance benchmarks (e.g., from other health insurance plans or contracts), to more accurately and confidently establish goals.
(5) Trending and forecasting techniques to translate end-of-year goals into monthly objectives and to forecast end-of-year performance based on actual year-to-date data.
(6) Context-based drill-down links, providing point-and-click navigation through the visual dashboard interface to actionable member-level data.

Depending upon application, any one or more of these features may be provided within the overall concept and solution architecture, depending on desired scope and individual user needs, with or without any of the additional features described herein. More generally, these different features enable Medicare payers and other users to more easily and effectively manage their CMS Star programs, by providing the visual intelligence needed to set targets, manage action plans, and achieve desired quality of care and ratings goals. Built-in performance gap analysis and clickable drill-down interfaces are also provided, so that users can prioritize opportunities and follow those most likely to improve overall performance. More intuitive and interactive dashboard interface and reporting structures also enable users to quickly spot trends in CMS measure-based performance criteria, identify underlying causes, and take appropriate action to leverage opportunities for improving overall care and efficiency, while reducing quality escapes and other loss mechanisms.

Platform Overview

The CMS Stars data management platform encompasses computer and server-based data management systems and methods designed to align Medicare Advantage program goals around CMS measure-based priorities, for improved healthcare plan coverage, efficiency, and performance. The platform provides improved graphical dashboard-type interfaces with greater transparency to drive engagement and support across the insurance provider (or Medicare payer) organization, distribute accountability for maintaining and improving Stars measures and ratings, and ensure ownership by key constituents to deliver better, more efficient healthcare services to individual plan members on a contract-by-contract basis, with a global goal of improving the overall health of the general population, at reduced cost.

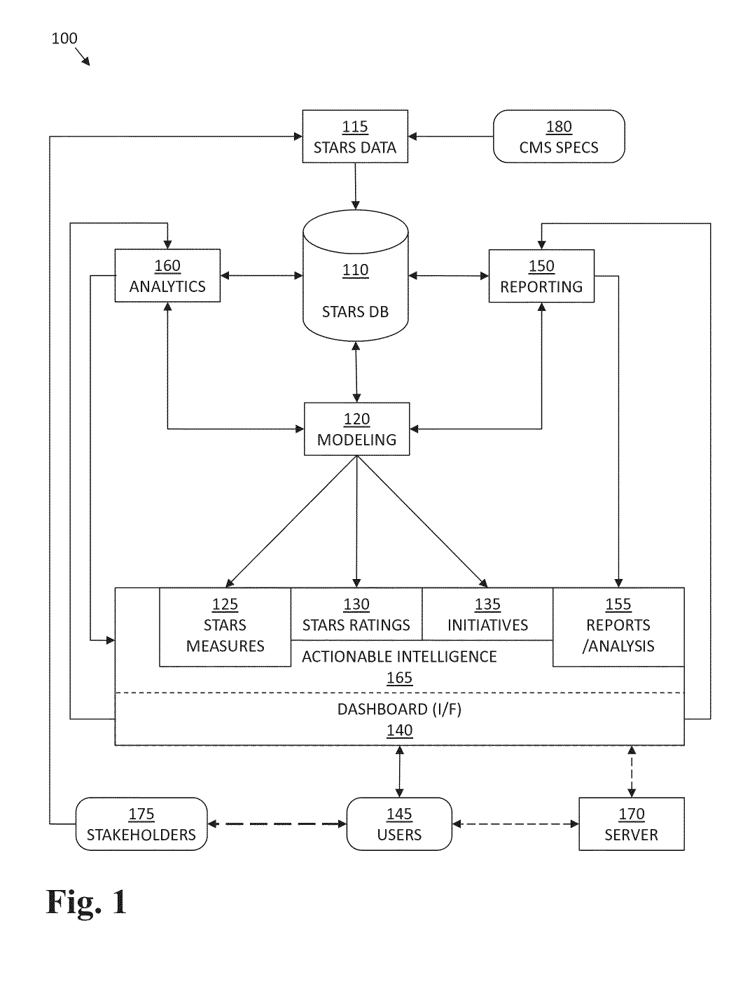

FIG. 1 is a block diagram of a representative computer-based data management and analysis platform (or system) 100, as directed to CMS Stars rating measures and related program data. As shown in FIG. 1, system 100 includes database (DB) 110 for storing CMS Stars program data 115; modeling processor (μP) 120 for modeling CMS measures 125, forecasting CMS Stars ratings 130, and prioritizing initiatives 135; dashboard interface (I/F) 140 for user 145; reporting module (R/M) 150 for dynamic reporting and analysis 155 of the modeled CMS measures 125 and forecasted CMS Stars ratings 130; and analytics module (AIM) 160 for converting CMS Stars data 115 into actionable intelligence 165. Actionable intelligence 165 may be made available to user 145 via dashboard interface 140, for example as expressed in one or more of the modeled CMS measures 125, predicted CMS Stars ratings 130, prioritized initiatives 135, and dynamic reporting output 155.

Stars platform database 110 is configured to store CMS Stars data 115, including benchmarks and historical CMS measures and Stars ratings, as described herein, and as related to actual and estimated (or modeled) CMS measures 125 and Stars ratings 130. Database 110 typically incorporates a networked storage server system in data communication with modeling, reporting and analytics modules or processors 120, 150, and 160, respectively. Dashboard interface 140 is also provided in data communication with Stars platform database 110, either directly or via one or more of the processing modules 120, 150, and 160 (or both).

Similarly, dashboard interface 140 may be provided in direct communication with one or more users 145, or users 145 may connect to dashboard interface 140 via a network or cloud-based server 170. In these applications, Stars management platform (or system) 100 may be embodied in a server-based data management and analysis system, and configured for independent management and analysis of different CMS Stars data sets 115 for any number of remote and local users 145.

Users 145 include contract managers and plan administrators for different Medicare Advantage insurance programs. In particular, users 145 may include managers, administrators, analysts, data specialists and other individual or group owners who have been identified or assigned responsibility for different CMS measures 125. For these users, dashboard interface 140 also provides interactive tools and information for tracking corresponding initiatives 135 and status update reporting 155, in order to report on progress in the initiatives, as directed to achieving selected healthcare service goals and corresponding CMS Stars ratings 130.

Modeling processor or module 120 enables program administrators, plan managers and other users 145 to model or estimate CMS measures 125 and forecast CMS Stars ratings 130, and to prioritize initiatives 135 in order to set intelligent yearly goals for improved member care. Management platform 100 utilizes a combination of historical plan performance and CMS technical specifications in order to estimate current results, and to prioritize opportunities for improved performance across the different modeled CMS measures 125.

Modeling processor 120 also guides user 145 with respect to what goals and initiatives 135 are most achievable, based on modeled CMS measures 125 and the distance to the next predicted CMS Stars rating 130, using corresponding CMS Stars data 115, including benchmarks and historical measures and CMS Stars ratings. Utilizing interactive components on dashboard I/F 140, user 145 can establish such user-selected or initial goals for individual CMS measures 125, and upload them into a data repository or database 110 for use in dashboard interface 140 and reporting module 150.

Dashboard interface (I/F) 140 provides interactive tools for users 145 to interact with CMS Stars management platform 100, including anyone from executives to analysts, in order to quickly and easily determine performance gaps and recent trends with respect to CMS measures 125 and Stars ratings 130, and corresponding improvement priorities for different possible initiatives 135. Using the intuitive graphics interface of dashboard 140, users 145 can visually monitor performance against goals, and quickly navigate through the large complex CMS stars data 115 in platform database 110, in order to identify priorities for initiatives 135 that are most likely to impact results for CMS measures 125, and ultimately CMS Stars ratings 130.

Dashboard interface 140 provides users 145 with goal-focused information in the form of actionable intelligence 165, beginning with current performance reporting and analysis 155 and end-of-year and interim forecasts for CMS measures 125 and Stars ratings 130, which can be translated into actionable opportunities and initiatives 135, for example by modeling processor 120. Detailed intervention reports and other dynamic reporting 155 are generated by reporting module 150, in order facilitate targeted engagement between users 145 with oversight by owners of the different CMS measures 125, and the different plan members, service providers, and other stakeholders 175, in order to achieve the stated goals for CMS measures 125 and Stars ratings 130.

Reporting processor or module 150 generates intervention reports and other dynamic reporting output 155, based on Stars data 115 in platform database 110, including historical data and benchmarks. Analysts, data specialists, and other platform users 145 can interactively drill down and across multiple levels of data reporting and analysis 155, in order to drive changes in CMS measures 125 and Stars ratings 130 by pursuing identified initiatives 135. Dashboard interface 140 dynamically links reports and analysis 155 within and across the various dimensions of Stars data 115 in platform database 110, allowing users 145 to analyze summary reports 155, and follow any one of multiple paths to engage members, providers, provider groups and other stakeholders 175. Actionable intelligence and other information 165 is intelligently arranged within dashboard (or user interface) 140, in order to focus efforts on achieving goals for CMS measures 125 and Stars ratings 130, and reporting 155 can be sorted and re-sorted based on priority and other attributes in order to spot trends in CMS Stars data 115, and to consolidate actions and initiatives 135.

Analytics module or processor 160 supports the user tools provided by interface 140, providing a powerful analytics engine configured to convert CMS Stars data 115 in database 110 into actionable intelligence 165 for users 145. In addition, Stars management platform 100 provides a range of flexible options for accepting CMS Stars data 115 from a variety of different sources, including, but not limited to, service providers, members, and other stakeholders 175.

Analytics module 160 works together with modeling processor 120 to determine historical trends in CMS Stars data 115 for use in forecasting Stars ratings 130, translating longer term (e.g., quarterly or year-end) goals into shorter-term (monthly or even weekly) targets for individual CMS measures 125. Analytics module 160 also coordinates with reporting module 150 to generate multiple-level summaries and other dynamic reports and analysis 155, based on CMS Stars data 115 and CMS technical specifications including scoring requirements, benchmarks, and CMS technical specifications 180, for example as defined or provided by CMS and the other rating agencies and organizations described above. Taken together, these analytic capabilities and interactive user tools provide Stars platform 100 with the capacity to help both users 145 and stakeholders 175 meet increasingly higher healthcare goals, while working together to increase program efficiency and reach financial goals.

Computer-implemented applications include CMS program data management servers and platform systems. These systems may include a database with memory configured for storing historical CMS raw scores, historical CMS Stars ratings, and updated CMS data for an insurance program. Performance benchmarks and benchmark improvements can also be stored, based on historical performance of selected (e.g., high performing) insurance plans and contracts.

A computer processor or computer processing system is provided in communicative coupling with the database, and configured to calculate CMS raw scores based on the updated CMS data. The computer system can also forecast CMS Stars ratings for the insurance program, based on the calculated CMS raw scores, and output the forecast CMS Stars ratings to the user interface.

Depending on application, the system may include a model processor or modeling module configured to forecast the CMS measures at a future date, based on the historical CMS raw scores and the updated CMS data. For example, the updated CMS data may include year-to-date raw scores for CMS measures corresponding to the modeled or forecast CMS Stars ratings. Such a model processor can also be configured to determine performance gaps for the calculated CMS raw scores, based on differences between the calculated CMS raw scores and seasonally-adjusted target CMS raw scores.

The user interface can be configured to display the forecast CMS Stars ratings in a rank order based on the performance gaps, or based on performance goals for the CMS Stars ratings. For example, the rank ordering can be based on a weighted variance or variation of the goals, where the weighting is defined by CMS technical specifications for aggregating the respective CMS measures into consolidated Star ratings by domain.

The computer system or model processor can also be configured to output initiatives to the user interface. Typically, the initiatives describe one or more user actions directed to closing the performance gaps, for example via contact or communication with a healthcare provider or plan member.

Performance goals can be selected based on achievable improvements for CMS measures corresponding to the CMS Stars ratings, based on the benchmarks and benchmark improvements stored in the database. For example, particular achievable improvements may be identified as having actually been achieved for the corresponding CMS measures by selected insurance programs, for example top quartile CMS Stars rated programs.

The user interface can be configured to receive a target value for CMS measures corresponding to one or more of the forecast CMS Stars ratings, and the computer system can update the forecast CMS Stars ratings based on the target values. Updating can be performed at a domain level corresponding to the corresponding CMS measures, or at a part or contact level for the insurance plan.

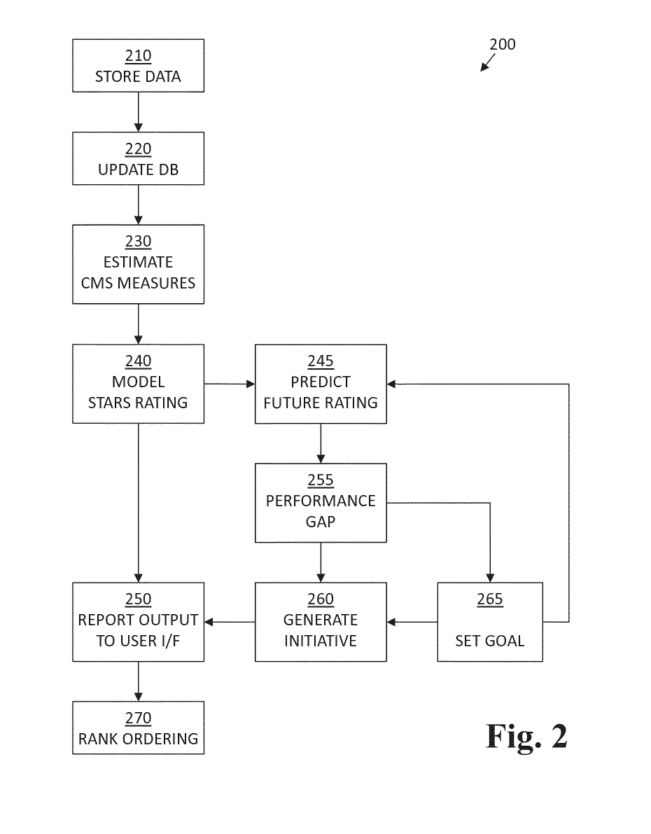

FIG. 2 is a block diagram of a representative computer-based method 200 for management and analysis of data related to a CMS Stars rating program, for example as applied to a Medicare Advantage insurance program, insurance plan, or insurance contract, under Medicare Part C or Part D. As shown in FIG. 2, method 200 may comprise one or more steps including, but not limited to, data storage (step 210), updating the database (step 220), calculating CMS measure trends (step 230), modeling CMS Stars ratings (step 240), and reporting output to a user interface (step 250). Depending upon application, CMS Stars rating program data management method 200 may also include one or more steps of forecasting future CMS Stars ratings (step 245), determining performance gaps (step 255), identifying initiatives (step 260) to close the performance gaps, and setting targets and goals (step 265) for particular CMS measures and Stars ratings.

Storing data (step 210) may include storing historical CMS measures and historical CMS Stars ratings in a database. The historical CMS measures and Stars ratings are typically associated with insurance programs or contracts that have already been subject to the CMS Stars rating process. The database or repository may include data obtained from the same contract that is currently selected for analysis, or from other contracts, or both. The database is typically provided in communication with a computer system having a user interface, for example as described above for platform database 110 of Stars management system 100.

Updating the database (step 220) includes storing CMS Stars measurement data on a non-volatile data storage medium. The measurement data are defined by the CMS measures of interest, which in turn are defined by Centers for Medicare and Medicaid Services, and its associated agencies and organizations. Depending on the CMS measures, updated measurement data may be collected from a variety of plan data files plan administrators and other stakeholders.

Estimating the CMS measures and measure trends (step 230) and modeling the CMS Stars ratings (step 240) are typically performed by a computer system, for example using a modeling processor or analytics module, as described above. The CMS measures are estimated based on the updated CMS measurement data, which can be provided and utilized in substantially real time, or on a weekly, monthly, or other periodic basis, to produce current CMS measure estimates, as opposed to waiting until the end of the plan year, as in other techniques. Historical CMS trends and CMS year-to-date data are generated for the insurance program or contract, based on the historical CMS date (e.g., raw scores) and the updated CMS Stars ratings data (that is, updated compliance data and other data related to the CMS measures and CMS Stars ratings).

The model results are reported as output (step 250) to a user interface, for example a dashboard type user interface 140, as described above with respect to FIG. 1, or as described elsewhere herein. The user interface may be local or remote, and may include any combination of network server, cloud-based, and direct communication links configured for data communications with the user, database, and computer system, including its various modeling, reporting, and analytic components.

CMS Stars ratings may be modeled (step 240) in real time to produce current (or substantially current) results, based on the estimated CMS measures. Alternatively, the CMS Stars ratings may be modeled or forecasted at a future time (step 245), based on a combination of current estimated CMS measures and trending, using historical CMS data (e.g., raw CMS measure scores) and historical CMS Stars ratings (or data representing this ratings). The trending analysis can also utilize seasonally adjusted data to account for performance patterns observed in the member and service provider populations, as described below. Depending upon application, both CMS Stars ratings and the corresponding CMS measures or “raw scores” may be modeled and forecasted, in order to provide for a combination of ratings-based (CMS Star) and “raw score” (CMS measure) modeling, forecasts, and goal setting.

Performance gaps (step 255) can be determined based on the differences between current calculated CMS Stars ratings and the corresponding user-defined or system-defined goals. Performance gaps can also be expressed in terms of the CMS ratings (stars), members with gaps in care for the given HEDIS measure, or other corresponding CMS measures (raw scores). In the case of both “standard” and “inverted” CMS metrics, where higher raw scores may correspond to higher or lower CMS ratings, respectively, the performance gap is typically defined as negative or red when improvements are desired, and positive or green when the desired target or goal has been achieved or exceeded.

Initiatives (step 260) can be identified as a user-defined procedure. Typically, initiatives are designed to close performance gaps, for example by contacting a healthcare provider to complete required record keeping, or by contacting plan members (either directly, or through the providers), in order to encourage (or verify) screenings, vaccinations, and other preventative care measures.

Initiatives can also be determined as a function of user-based or system-calculated goals (step 265). The computing system can identify achievable goals based on historical data, for example using actual improvements achieved by high-performing populations (e.g., the top 25% or top 50% of plan contracts), or based on past experience with the selected contract itself. Alternatively, user-defined goals can also be utilized, for example as input via the user interface, and using the corresponding modeling tools described herein. In addition, goals can also be defined either based on particular CMS Stars ratings (star-based goals or targets), or using the underlying CMS measures (raw-data based goals and targets).

More generally, the above steps may be performed in any number, combination or order, with or without additional functions. In some applications, for example, the Stars ratings or CMS measures (or both) may be rank ordered (step 270), either before or after output to the user interface (step 250). In some applications, one or both of the modeled CMS measures and actual or forecast Stars ratings may be rank ordered and displayed according to the corresponding performance gaps (step 255), for example in order of gap size, or compliance rate. In these applications, the performance gaps may describe care gaps, based on the difference between actual care provided to insurance plan members, and the goals for care provided to the plan members.

In computer-implemented modeling applications, historical CMS raw scores and historical CMS Stars ratings may be stored in a database or repository, which is in communication with a computer system and user interface. The database also stores performance benchmarks based on historical data for selected insurance plans or contracts, for example high-performing (top 25% or top 50% CMS Stars rated) plans or contracts, which have actually achieved the stored benchmarks in CMS measures (raw scores) or CMS Stars ratings, or in corresponding improvements to such measures.

The database is updated with CMS Stars ratings data for the insurance program of interest, for example year-to-date raw score data for the various CMS measures corresponding to the CMS Stars ratings. Updating can be performed with data from plan members (e.g., surveys), healthcare providers, or other parties (independent ratings groups, or the CMS itself), or, in some cases, user-provided information.

The computer system is used to calculate or estimate CMS raw scores for the insurance program, based on the updated CMS Stars rating data, and to model current (e.g., year-to-date estimated) or future (forecast) CMS Stars ratings for the insurance program, based on the calculated CMS raw scores, and the modeled CMS Stars ratings are output to the user interface.

Depending on application, for example, historical CMS trends and CMS year-to-date data can be generated for the insurance program, based on the historical CMS raw scores and the updated CMS Stars ratings data. CMS Stars ratings can also be forecast for the insurance program, based on the historical CMS trends and the CMS year-to-date data, and the forecasts can be output to the user interface.

The computer system can also be used to determine performance gaps for the insurance program, based on differences between the modeled CMS Stars ratings and user-defined goals. The user interface provides for inputting the goals, and outputting the performance gaps for display. The interface can also be used to assign accountable owners (e.g., selected organizational users) to particular CMS measures corresponding to the CMS raw scores, and to assign initiatives and status updates to the accountable owners. The initiatives may describe user actions intended to close the performance gaps, for example via contact with a healthcare provider or member of the insurance program, and the status updates may describe status of the initiatives, and corresponding user actions.

In some applications, the system is used to generate achievable goals for one or more of the modeled CMS Stars ratings, where the achievable goals are based on benchmark performance (or performance improvements) stored in the database. The benchmarks represent historical performance of selected insurance plans, or improvements in historical performance, for given CMS measures corresponding to the achievable goals. The insurance plans may be selected based on performance, for example top-performing plans selected from a top quartile or top half of insurance plans for which historical data are available for the given CMS measures.

Goal-based modeling and forecasting can be performed by utilizing the interface to receive initial or user selected goals related to a prior year CMS Stars ratings, for selected CMS measures. The modeled CMS Stars ratings (e.g., modeled ratings goals through end-of-year and modeled forecast ratings) are then updated for the selected measure, based on the user selected goals.

For example, the modeled CMS Stars ratings can be updated at a CMS measure level, or at a measure domain level corresponding to the selected measure, based on corresponding user selected goals. The modeled CMS Stars ratings can also be updated at a contract or part level for the insurance plan, corresponding to the selected measure. The user selected goals may be raw score based target values for selected CMS measures, or star based targets for the modeled CMS Stars ratings, corresponding to the selected CMS measures.

Modeling the CMS Stars ratings may include modeling current or year-to-date values for the CMS Stars ratings, based on the calculated CMS raw scores. Future values for the CMS Stars ratings can also be forecast, based on the historical CMS raw scores and the updated CMS Stars ratings data, and performance gaps can be determined based on differences between the modeled current values and the forecast future values.

The CMS Stars ratings can be rank ordered with the computer system, based on the performance gaps, and output to the user interface for display, in the rank ordering. In these examples, the performance gaps may describe care gaps based on a difference between care provided to members of the insurance program, and goals for providing care to the members.

### Authentication, Access and Enrollment

The platform database or repository (e.g., database 110 of FIG. 1) may include authentication tables with data defined to handle user login and authentication. Enrollment tables can also be provided, and utilized to assign individual members into the plan contracts.

Roles are assigned to particular users based on the organization to which they belong (e.g., a particular Medicare payer or insurer), for a particular contract (e.g., a contract for a Medicare Advantage insurance plan). Thus, user access and user roles are typically defined a contract level, although some users may have access to multiple contracts associated with a particular organization, and such users may have the same or different roles within each separate contract.

Organizational administrative users have the ability to assign roles and grant access to other users at either the contract or organization level. Organizational administrative users may have access to contracts across different business entities, depending on organizational or corporate structure, and desired level of access. Some system administrative users may also have access across different contracts within a particular user organization.

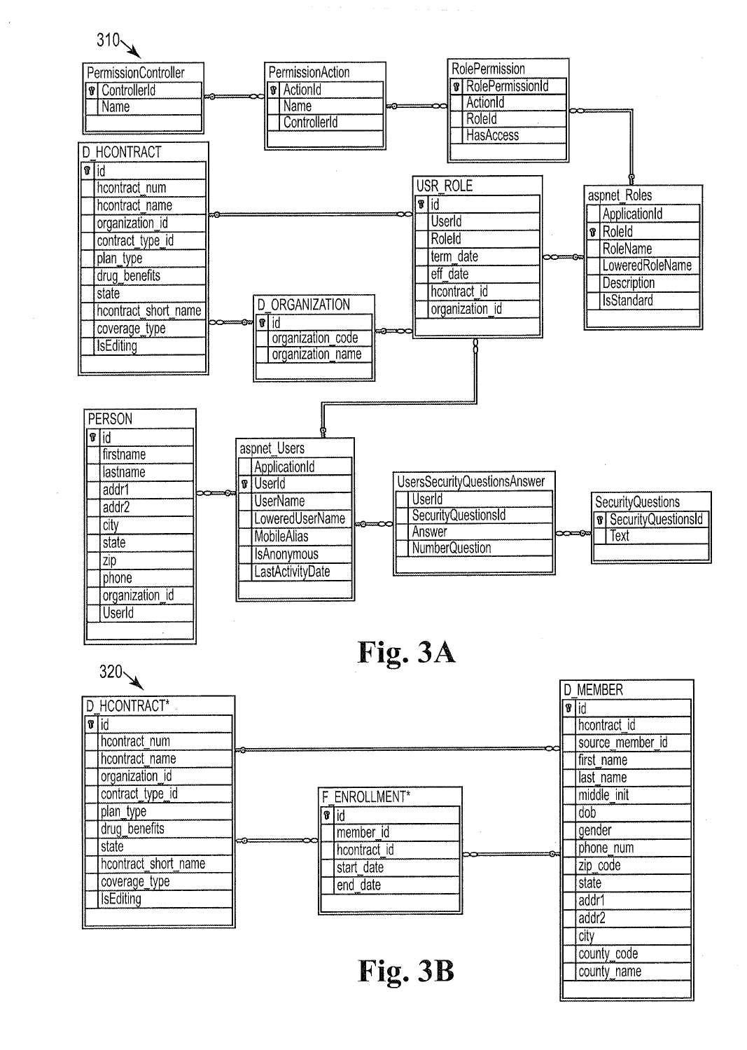

FIG. 3A is a schematic diagram of a representative authentication data structure 310. As shown in FIG. 3A, authentication data structure 310 includes Permission Controller, Permission Action and Role Permission Tables with controller (administrative user) identification data, action identification data, and role permission identification data, respectively, to control what functionality individual users have access to, based on their defined role within the contract. Authentication data structure 310 may also include a Contract Table with contract data (D_HCONTRACT), an Organization Table with organization data (D_ORGANIZATION), a Person Table with personal data (PERSON), and a User Role Table with user identification data and corresponding contract, organization, and user data (USR_ROLE). Supplemental Security Questions and User Security Questions Answer Tables may also be included for user security data, with a dynamic server based User Table and Role Table for user identification information (aspnet_Users) and role identification information (aspnet_Roles), respectively.

FIG. 3B is a schematic diagram of a representative enrollment data structure 320. As shown in FIG. 3B, enrollment data structure 320 includes the Contract Table (D_HCONTRACT or D_HCONTRACT*), an Enrollment Table with member identification and enrollment dates (F_ENROLLMENT or F_ENROLLMENT*), and a Member Table with contract identification and member data (D_MEMBER).

Enrollment information is provided at the individual member level, with individual members assigned to particular contracts, as defined for particular member months based on the contract membership start and end dates. Members are also identified by unique system ID numbers, and may be defined as unique to a particular contract so that the same member system ID number will not be matched to another contract, within a given member month or other time period.

### CMS Measurement Data

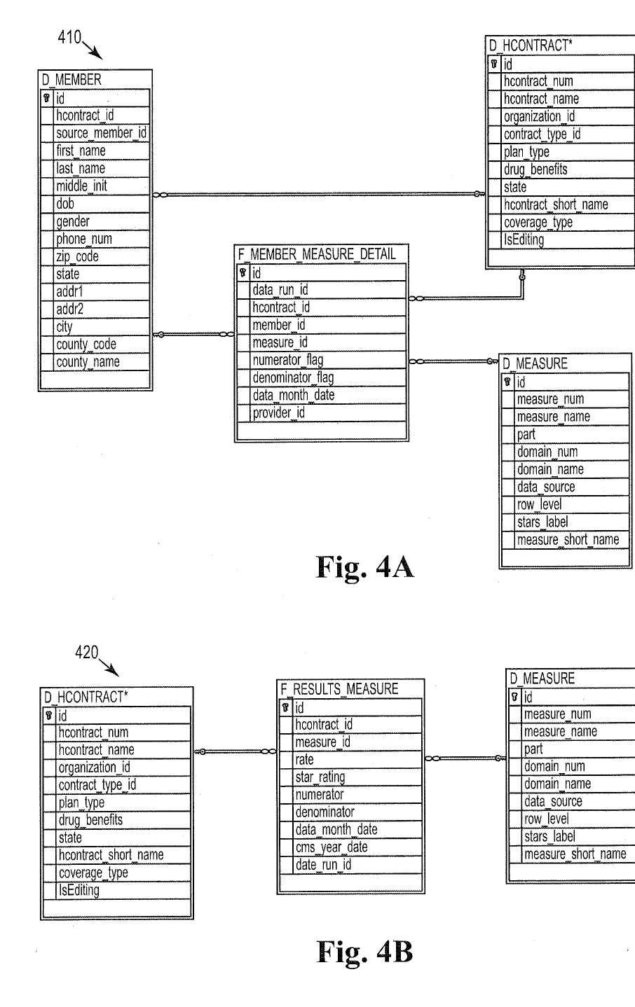

FIG. 4A is a schematic diagram of a representative Healthcare Effectiveness Data and Information Set (HEDIS) data structure 410. As shown in FIG. 4A, HEDIS data structure 410 includes the Member Table (D_MEMBER) and Contract Table (D_HCONTRACT or D_HCONTRACT*), as described above. HEDIS data structure 410 may also include a CMS measure Table with data identifying the measure name and the domain to which it is assigned (D_MEASURE), along with a Member Measure Detail Table identifying the member and contract with a specific healthcare provider, and providing particular measurement data.

This particular HEDIS data structure holds compliance information for each member, measure, and month combination, which can be utilized to generate detailed reports of members who are compliant (or non-compliant), for particular CMS measures. The data may also be used as a source for aggregated summaries of measurement data at different member, provider, and contract levels, for better performance in reporting.

Compliance for the different HEDIS measures and member-level results can be loaded into the Measure Level Results data structure, as described below. The Member Measure Detail Table data are associated with the Contract Table data to determine the contract that the identified member was enrolled in during the month that the corresponding data were recorded, for example based on data in the Enrollment Table (above).

FIG. 4B is a schematic diagram of a representative measurement level data structure 420. As shown in FIG. 4B, measurement level data structure 420 includes the Contract Table (D_HCONTRACT or D_HCONTRACT*), the CMS Measure Table (D_MEASURE), and a Results Measure Table (F_RESULTS_MEASURE). The Results Measure Table includes contract and measurement identification data, month and year data, and corresponding CMS Stars rating data, as defined at the individual measure (or measurement) level.

The measure level result tables can be populated in a variety of different ways, depending on the data source. At the member level, for example, HEDIS data stored in the Member Measure Detail Table of FIG. 4A (above) can be aggregated into the Results Measure Table of FIG. 4B. Similar data structures may be defined for Consumer Assessment of Healthcare Providers and Systems (CAHPS) data, patient-reported Health Outcomes Survey (HOS) data, and other data sources, for example with the individual tables populated by user entry screens and other (e.g., automated) data import functionality.

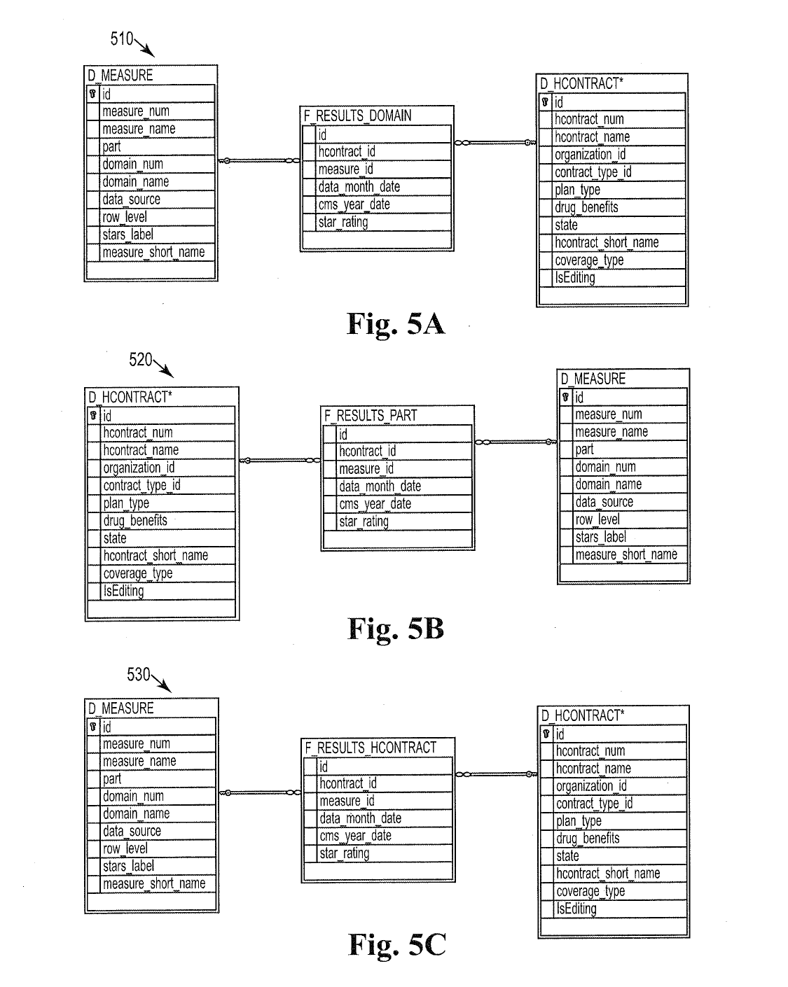

FIG. 5A is a schematic diagram of a representative domain level data structure 510. As shown in FIG. 5A, domain level data structure 510 includes the Contract Table (D_HCONTRACT or D_HCONTRACT*), the CMS Measure Table (D_MEASURE), and a Results Domain Table (F_RESULTS_DOMAIN). The Results Domain Table includes contract and CMS measurement identification data, along with month and year data and associated CMS Stars rating data, as defined at the domain level.

At the level of domain level data structure 510, the Results Domain Table can be populated using data from the individual Results Measure Tables (above), applying domain scoring logic from the CMS technical specifications and benchmarks to obtain corresponding CMS Stars ratings. Note that the connection between the Results Domain Table and the Measure Table is represented in FIG. 5A at the domain level, rather than at the individual measurement level as shown in FIG. 4B.

FIG. 5B is a schematic diagram of a representative part level data structure 520 (e.g., Medicare Part C or Part D). As shown in FIG. 5B, part level data structure 520 includes the Contract Table (D_HCONTRACT or D_HCONTRACT*), the CMS Measure Table (D_MEASURE), and a Results Part Table (F_RESULTS_PART). The Results Part Table includes contract and CMS measurement identification data, along with month and year data and associated CMS Stars rating data, as defined at the part level (e.g., Medicare Part C or Part D)

The Results Part Table can be populated using data from the individual Results Measure Tables (above), applying part scoring logic from the CMS technical specifications to obtain the corresponding part-level CMS Stars rating data. In FIG. 5B, the connection between the Results Part Table and the Measure Table is represented at the part level, as opposed to the domain level connection of FIG. 5A and the individual measure level connection of FIG. 4B.

FIG. 5C is a schematic diagram of a representative contract level data structure 530. As shown in FIG. 5C, contract level data structure 530 includes the Contract Table (D_HCONTRACT or D_HCONTRACT*), the CMS Measure Table (D_MEASURE), and a Results Contract Table (F_RESULTS_HCONTRACT). The Results Contract Table includes contract and CMS measurement identification data, along with month and year data and associated CMS Stars rating data, as defined at the contract level.

Depending on application, this particular data structure may be applied to Medicare Advantage Part C or Part D (MA or MA-PD) contracts, for example including prescription drug benefits. The Results Contract Table can be populated using data from the individual Results Measure Tables, above, applying part or contract scoring logic from the CMS technical specifications, depending upon application. In FIG. 5C, the connection between the Results Contract Table and the Measure Table is represented at the contract level, as opposed to the part level of FIG. 5B, the domain level of FIG. 5A, and the individual measure level FIG. 4B.

### Platform System and Dashboard Interface Components

CMS Stars ratings are calculated and maintained using complex data sets and analytics based on annual technical specifications published by the Centers for Medicare and Medicaid Services (CMS). The Stars management platform is designed to enable users involved in CMS Stars initiatives to manage Stars-rated programs including Medicare Advantage insurance contracts more effectively through improved reporting, goal setting, intervention, and plan administration. The end results include increased healthcare quality and improved patient outcomes, and potential growth in membership and health plan reimbursement.

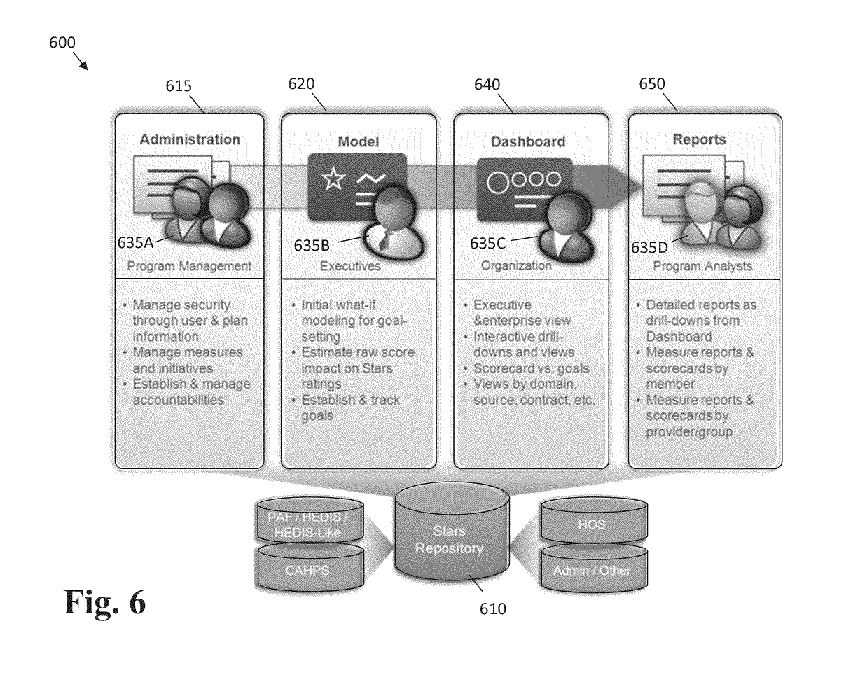

FIG. 6 is a schematic illustration of a representative CMS Stars management platform or system 600. Depending on embodiment, Stars platform 600 may include one or more components including, but not limited to, Stars repository or database 610, administration module 615, modeling module 620, dashboard interface module 640, and reporting interface module 650.

Administrative module or interface 615 enables administrative users 635A to manage other administrative and non-administrative users 635A, 635B, 635C and 635D, as well as individual CMS measures and contracts. Administrative users 635A have the ability to create other users 635A-D, and modify their associated user information, roles, and access levels. Administrative users 635A can also input health plan contracts and related plan administration information, modify organization and contract goals, assign CMS Star measure owners, and generate or modify initiatives, status updates and other reporting for the various CMS Star measures and ratings.

Modeling module or interface 620 enables program administrators and other executive users 635B to estimate CMS Stars ratings, prioritize initiatives, and set future performance goals, e.g., for an upcoming month, quarter or year. Stars management platform 600 utilizes historical performance and CMS technical specifications to estimate current year results, and prioritize available opportunities for improvement.

Modeling interface 620 guides model-authorized users 635A and 635B as to what goals are achievable, based on distance to the next star rating and benchmark data. Using interactive components in modeling interface 620, users 635A and 635B can establish goals for individual CMS measures, and upload them into Stars data repository 610 for use in dashboard (or user interface) 640 and reporting interface 650.

Dashboard interface 640 provides interactive tools for all organizational users 635C, in order to determine trends in CMS measures and ratings, evaluate performance gaps between the corresponding goals and actual plan or contract performance, and determine priorities for improvement initiatives. Organizations users 635C can also monitor actual performance against selected goals, and identify priorities for initiatives based on ability to impact the year-end or monthly results.

Information provided by dashboard interface 640 is goal-focused, beginning with current performance and end-of-year forecasts for the different CMS measures and ratings. Detailed intervention reports are generated, in order to facilitate targeted engagement between organizational users 635C who are assigned ownership of or take responsibility for particular Stars measures, and the particular plan members, healthcare providers and other stakeholders whose actions may determine and help improve the corresponding measures.

Reporting interface 650 is utilized by analysts and specialist users 635D, in order to drill down and across multiple data levels to generate changes in the CMS measures and ratings. Reports are dynamically linked from the dashboard screen and within the reporting interface, allowing analyst and specialist users 625D to analyze summary reports and follow multiple paths to engage the appropriate plan members, healthcare providers, and provider groups that can determine and help close performance gaps in the CMS Stars measures. Reporting information is arranged to focus efforts on achieving goals, and can be sorted and re-sorted based on priority, compliance, and other attributes.

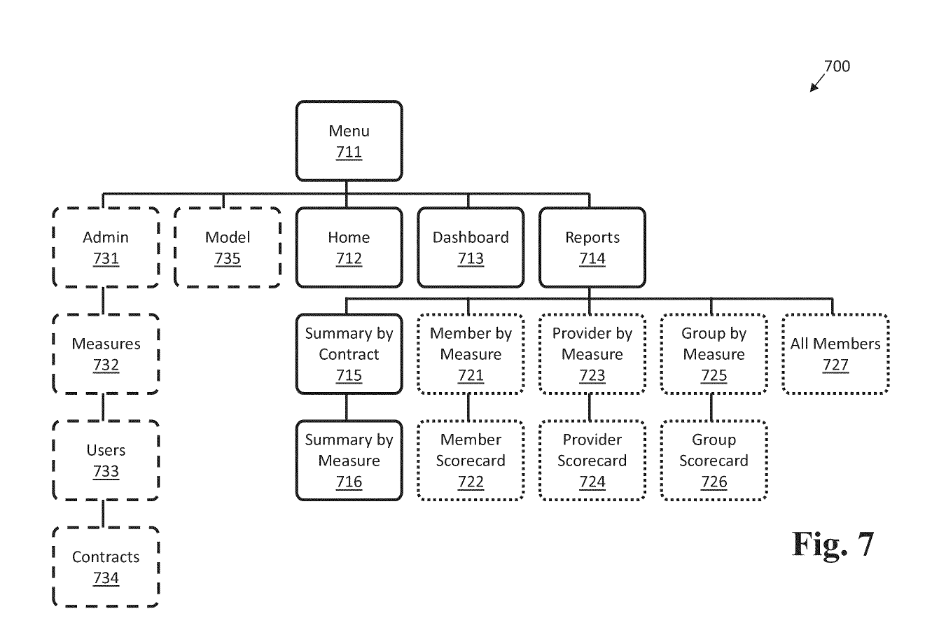

FIG. 7 is a representative flow diagram (700) for operation of Stars platform 600, illustrating the menu and user access hierarchy. In particular, flow diagram 700 illustrates user hierarchy and linkages between various features of the application as related to menu page (or interface) 711, including basic user tools 711-716, protected health information (PHI) tools 721-727, and administrative tools 731-735.

Users without access to administrative functions and protected health information (PHI) include executives and other non-administrative, non-PHI users in the organization, wishing to keep informed about the CMS Stars program with contract-level to measure-level information. These users may have access restricted to only the tools and functions shown with solid outlines in FIG. 7, including, e.g., menu functions 711, home page 712, and dashboard features 713 Access to reporting functions 714 may be limited to summary by contract (contract-level) reports 715, and summary by measure (measure-level) reports 716.

Thus, non-administrative, non-PHI users may periodically use these summary-level reports and the dashboard to check the status of various initiatives, drive accountability by the assigned owners of different CMS Stars measures. Non-PHI users may also monitor current and end-of-year program impacts on corporate objectives, without the need for member and provider-level access or visibility.

Additional non-administrative users may also have access to protected health information (PHI) reporting. In particular, designated PHI users may have access to the additional reporting functions shown with dotted outlines in FIG. 7, including member by measure (member-level) reports 721, member scorecard reports 722, provider by measure (provider-level) reports 723, provider scorecard reports 724, group by measure (group-level) reports 725, group scorecard reports 726, and all member (individual or global level) reports 727.

Along with the non-PHI functionality (e.g., basic user tools and interfaces 711-716), the PHI group also has reporting access to view information at lower levels of detail, including member, provider and provider group level reporting functions 721-727. Client administrators are responsible for assigning the PHI role to particular users, based on organizational needs and security requirements. Example PHI user job functions include intervention specialists and certain program analysts.

Client administrators typically include Stars program managers and their delegates, who control security, access, and business configuration of the management platform tools. Administrative users may have full access to the complete breadth and depth of all the tools in the flow diagram 700, in order to manage the Stars program. For example, only client administrators may have access to the tools and interfaces shown with dashed outlines in FIG. 7, including administrative functions 731, measure definitions 732, user authorization 733, contract entry 734, and modeling configuration 735.

System administrators may also be designated. This is a role for technical users to provide support for the other user groups. System administrator access may be limited, for example to implement new client services and help test and trouble-shoot the various user tools, features and functions.

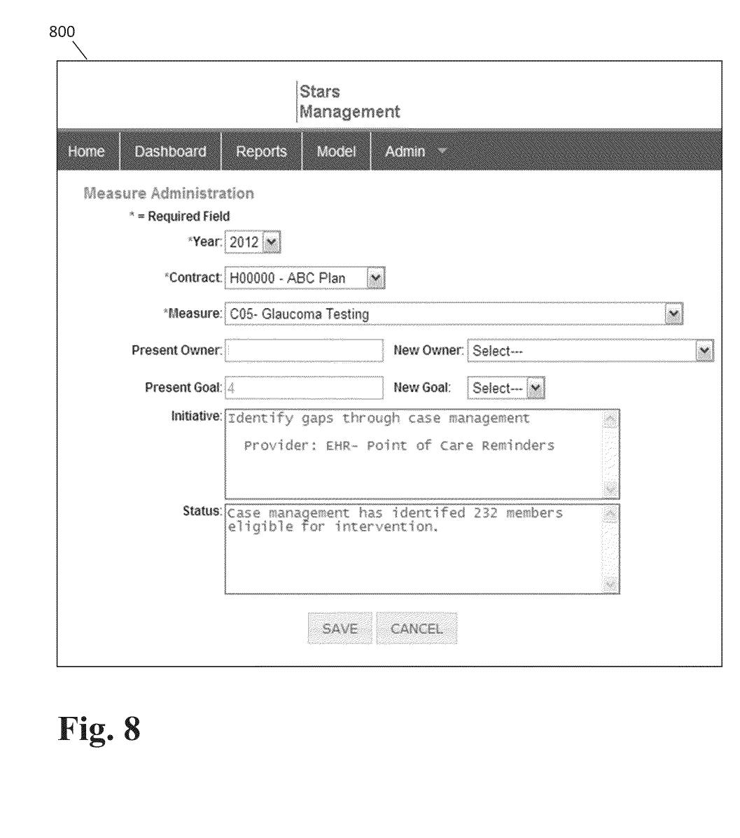

FIG. 8 is a schematic illustration of a representative CMS measure interface 800, for example interface tool 732, as described in flow diagram 700 of FIG. 7, above. CMS measure interface (page or tool) 800 allows (e.g., administrative) users to select a particular year, contract, and measure, and assign an owner within the organization who will be responsible for meeting plan goals directed to that measure, including directed intervention with members, healthcare providers, and other stakeholders as necessary to meet designated program goals.

The goals may be represented in terms of a CMS Stars rating or corresponding target value for the selected CMS measure, for example with a yearly or monthly target date. Initiatives may be identified in the context of directed intervention, for example interaction directed to contact providers or to contact individual plan members with a reminder to complete yearly screenings. Interface 800 may also provide the present status of the initiatives, for example the current number of members eligible for a designated intervention. Additional administrative tools 731 and 733-735 are also available, as described above.

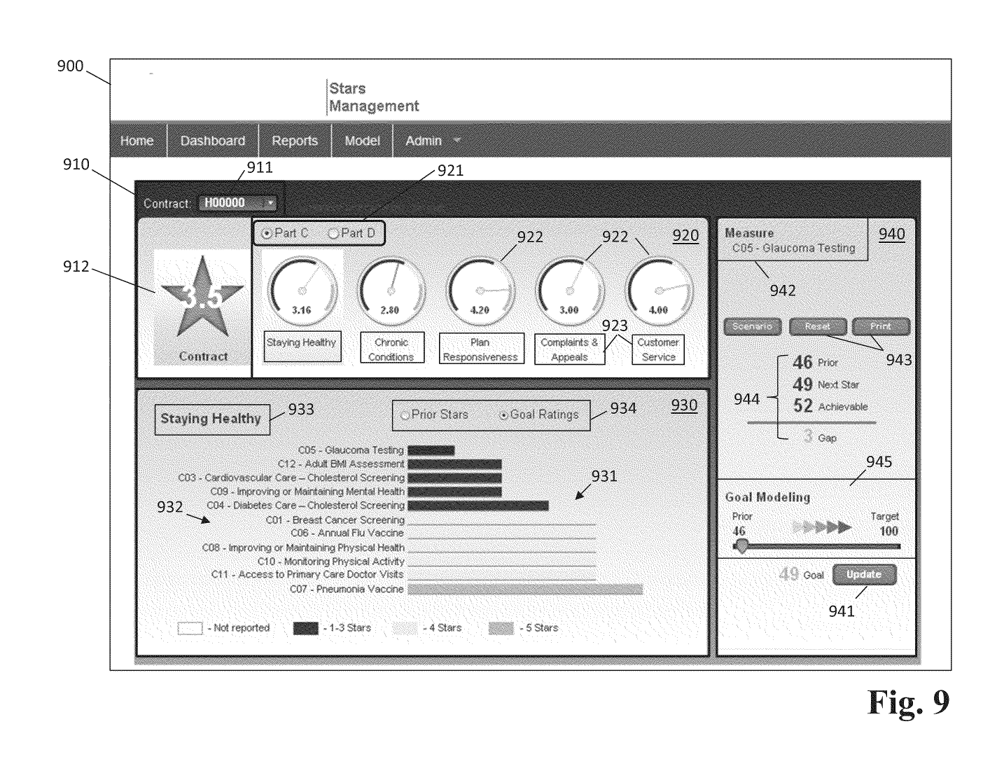

FIG. 9 is a schematic illustration of a representative user interface 900 for CMS Stars data management, for example user interface 140 of FIG. 1 or user interface 640 of FIG. 6, illustrating dashboard-type features, for example as embodied in dashboard interface (or dashboard screen) 713 of application flow diagram 700, as shown in FIG. 7, above. In the particular example of FIG. 9, user interface 900 provides one or more dashboard interface features, including contract summary panel 910 for contract summary data, domain summary panel 920 for domain summary data, CMS measure summary panel 930 for CMS measure summary data, and CMS measure detail panel 940 for CMS measure detail data.

While the various panels 910, 920, 930 and 940 are shown as shown in FIG. 9 as discrete regions or components of interface 900, in other applications panels 910, 920, 930, and 940 may have a different number or configuration. The various panels or components of interface 900 may also share one or more of the various functionalities described herein, or physically overlap.

Contract summary panel 910 includes contract selector/indicator 911 and contract performance display 912. Users may select a contract to display with contract selector 911, or to populate a given model. Contract performance is provided in display 912, for example in the form of an actual end-of-year CMS Stars rating, or a corresponding modeled rating value or raw CMS measure score.

Domain summary panel 920 includes Medicare Part C/Part D selector/indicator 921 and domain-level performance indicators 922. In this particular example, performance indicators 922 are represented as combination or alphanumeric and virtual dial (speedometer-type) displays, but purely alphanumeric or numeric displays are also contemplated, with or without virtual dials, bar graphs, and other graphical performance indicators.

Performance indicators 922 may display either prior year (actual) Stars ratings, or predicted or modeled values, depending upon user selection (e.g., in CMS measure summary panel 930, as described below). Each performance indicator 922 includes a domain label 923 identifying the corresponding CMS domain, for example using an abbreviated domain name to conserve space.

In the particular example of FIG. 9, domain labels 923 include Staying Healthy, Chronic Conditions, Plan Responsiveness, Complaints & Appeals, and Customer Service. Other domains are also contemplated, as determined by the Centers for Medicare and Medicaid services, and its associated agencies and organizations. Domain labels 923 may also be ordered, for example in either low-to-high or high-to-low stack-ranked order, based either on the CMS Stars ratings themselves or based on a performance gap (that is, the difference between the actual or modeled CMS Stars ratings or measures, and the desired or selected goals).

For example, the user interface may be configured to display modeled or forecast (predicted) CMS Stars ratings in a rank order based on goals for the CMS Stars ratings. The rank order may also be based a weighted variance or variation of the goals. For example, a weighted Star (or raw score) gap may be indicated on a bar graph by an amount to the left or right of a vertical goal line. The weighting is established by CMS technical specifications used for the respective CMS measures in aggregating consolidated Star ratings by domain level, part level, contract level, etc. Star and raw score performance gaps may also be indicated on a speedometer-type gauge (or other graphical indicator), for example by the distance of the needle to the right (positive) or left (negative) of its vertical center.

In some applications, performance indicators 922 or domain labels 923 (or both) are selectable (e.g., by clicking), in order to populate other areas of interface 900, for example CMS measure summary panel 930. Domain indicator/selector features 922 may also include alert features, for example color-coded perimeter and needle features, or other indicator features. In one particular application, elements of each domain indicator/selector 922 are color coded red for CMS Stars ratings values of 0-3, yellow for ratings of 3-4, and green for ratings of 4-5.

CMS measure summary panel 930 includes individual CMS measure displays 931 with measure name indicators or labels 932 for the selected domain, for example as determined via domain summary panel 920, above, and as indicated with domain indicator 933. The individual CMS measures can be displayed as bar graphs or other graphical indicators, or in alphanumeric form, and sorted either vertically or horizontally according to CMS Stars rating or performance gap. In particular, he CMS measures may be stack-ranked based on performance gap, and displayed in order from low to high or from high to low, arranged from top to bottom or left to right.

In some applications, individual CMS measure displays 931 or measure labels 932 (or both) may be selectable (e.g., by clicking), in order to populate CMS measure detail panel 940, as described below. CMS measure displays 931 can also include alerts, for example color-coded alert levels as described above for domain performance indicators 922 of domain summary panel 920.

View selector 934 is provided to choose a prior year (actual) Stars ratings, or a rating goal (e.g., a modeled rating, based on selected goal data). The “prior” stars selection thus provides historical performance data, while the “goal” rating selection shows the impact of a given model on each CMS measure in the selected domain, based on the desired goals. Selecting goal-based ratings also enables update button 941 in CMS measure detail panel 940.

CMS measure detail panel 940 includes update button 941, CMS measure indicator 942 and various reset and print controls 943. Data fields 944 may include end-of-year raw score data (e.g., from the immediately prior year), the next star threshold or cutoff point (as required to achieve the next-higher star rating), and a reasonably achievable raw performance score for the selected CMS measure, based on the contract's prior performance plus top performing plan benchmark improvements (e.g., actual gains by the top 25% or 50% of plans, historical plan or contract data, or other selected benchmark).

The performance gap is displayed as the difference between the achievable results value and the next CMS Stars rating threshold (that is, gap=achievable−next star). Where the gap is zero or positive, CMS measure detail panel 940 indicates a likelihood that it may in fact be possible to achieve the next-higher CMS Stars rating for this CMS measure, based on other high-achieving plan experience, or other improvement benchmark. Alternatively, the performance gap may be displayed as the difference between the prior year's raw score and the next star value, but this approach may or may not provide an indicator of whether closing the performance gap is likely to be achievable.

Goal modeling selector/indicator tool 945 allows the user (if authorized) to select and display a raw score goal for the CMS measure, for example using a virtual slider indicator control as shown in FIG. 9. Typically, goal/ratings view selector 934 must be operated in order to display the results in contract summary panel 740, domain summary panel 920, and CMS measure summary panel 930. Goal modeling selector/indicator tool 945 also provides a favorable direction indicator to show whether higher or lower raw scores lead to higher ratings. For most measures upward or higher is better, but several measures may have a reversed or inverse (downward) orientation. The direction indicator (e.g., an arrow) can provide a visual indicator to show which way to move the slider to select improved performance goals, regardless of how the raw score scaling is configured.

Goal modeling selector/indicator tool 945 also indicates a target value, which is the upper or lower limit of the measure, depending on its direction. In some measures, for example, the target value is 100, while for others it may be zero, or another number. Color coded alerts may also be provided, for example red or green alert features depending on whether the next star score can likely be reached by closing the performance gap, based on the achievable score benchmark. Update button 941 is operated to write a selected CMS measure goal into the data repository, for use in goal-based reporting and dashboard components. Additional controls 943 include a corresponding reset button, as described above.

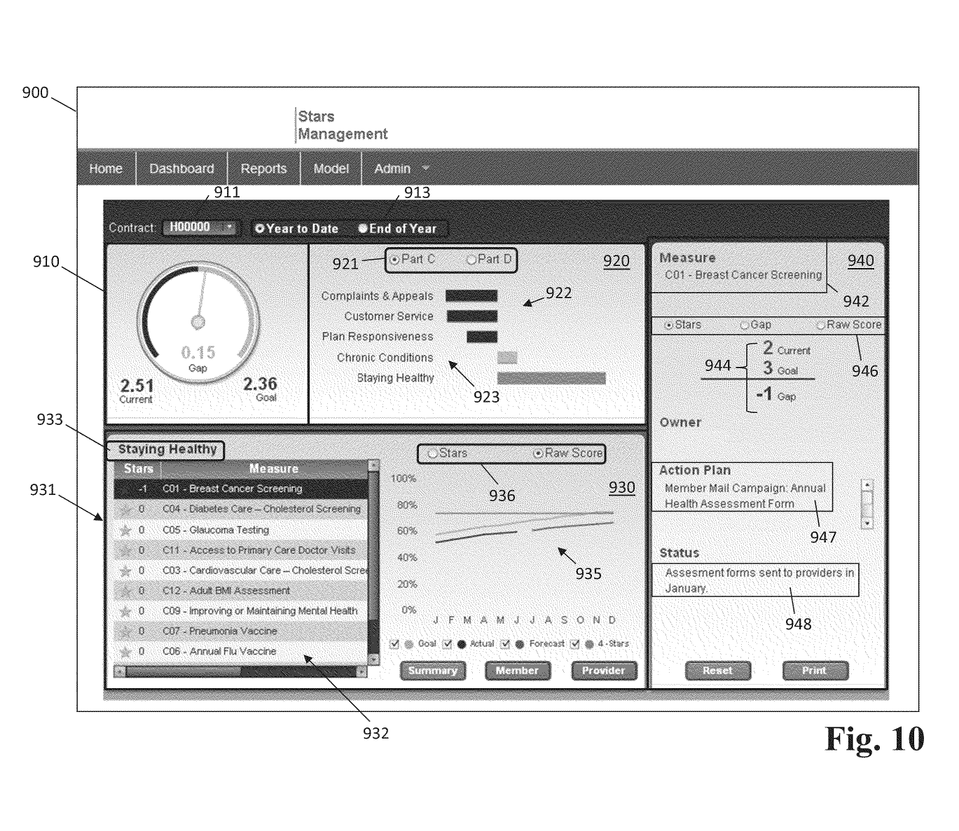

FIG. 10 is an alternate schematic view of user interface 900, illustrating additional modeling features, for example as embodied in modeling interface 735 of application flow diagram 700, as shown in FIG. 7, above. In the particular configuration of FIG. 10, user interface 900 includes contract summary panel 740 with contract selector 741, as described above with respect to FIG. 9. Timeframe selector 743 provides for year-to-date or end-of-year reporting options, for example as applied to all or part of user interface 900 during modeling operations.

As shown in FIG. 10, contract performance may also be evaluated in terms of a performance gap defined between the current (actual) performance the goal, rather than an actual CMS Stars rating. Where current performance may in fact be above the goal, moreover, as shown in FIG. 10, the indicator alert may be positive (e.g., green), with a corresponding positive gap value indicating that this a favorable performance condition. For all levels of measures, positive Star (or raw score) performance gaps generally indicate a favorable variance or variation, while negative Star (or raw score) gaps indicate an unfavorable variance or variation.

Domain summary panel 920 can also be modified, for example using bar graph type domain-level performance indicators 922 with domain labels 923, as shown in FIG. 10. Here, the domain goals are marked by or defined along a vertical line, with positive and negative alert indicators based on whether current domain performance is above (e.g., to the right of) or below (to the left of) the goal, respectively.

The Star rating (or raw score) gaps are defined as the difference between current performance of a given measure or domain, and the goal for performance. As shown in FIG. 10, bar graphs indicate the weighted Star gap as an amount to the left (e.g., negative/red/unfavorable) and right (e.g., positive/green/favorable) of the vertical goal line, as described above.

Other panels of the interface (or modeling interface) 900 can be populated with CMS measures from a particular domain by selecting the appropriate domain-level performance indicator 922, and current gap values can be displayed by hovering over a selected indicator 922.

As shown in FIG. 10, individual CMS measure displays 931 can be ranked based on performance gap, as measured in CMS star ratings. Color indicators (e.g., red for negative, green for positive or zero) can again be used. The individual CMS measure displays can also be ordered by raw score achievement gaps, and scrolling can be provided for longer lists of measures.

In a time-based analysis, trending data 935 can be presented in either CMS Stars or raw CMS measure score format, as determined by raw/star score selector 936. For example, a four-star or other performance goal may be defined, extending as a horizontal line on the trending graph. Both actual and forecast performance can also be plotted, with a seasonally adjusted goal based on historical trends for the contact population.

For example, screening and vaccine-related CMS measures may exhibit seasonal variation based on population travel patterns and seasonal illness cycles, such as influenza or other parasite or vector-borne illness. Based on this, the achievable goals may be adjusted to somewhat lower or higher values, depending upon whether the historical data indicate that the corresponding performance gap is relatively easier or relatively harder to close at a particular time of year. A series selection tool can also be provided, in order to display or hide the various trend lines.

Depending on application, examples of CMS measure detail panel 940 may include a stars/raw score or gap data type selector 946. An action plan or initiative indicator or display 947 may also be provided, along with a status display 948.

Dashboard-type and modeling interface applications include user interfaces for computer-based data management of CMS Stars rating program data. The interfaces typically include various panels or other functional components for user interaction with the data management and modeling system, for example a contract summary panel or module for selecting a health care contract, a domain summary panel or module for displaying domain-level CMS Stars ratings associated with the selected contract, and a measure summary panel or module for displaying CMS measures for CMS domains selected from the domain summary panel.

Depending on application, the contract summary panel can be used to select a time period for contract coverage, and a Medicare Part C or Part D option for the health care contract. The domain-level CMS Stars ratings can be rank ordered for display in the domain summary panel, based on performance gaps defined between calculated values and corresponding goals for the domain-level CMS Stars ratings. The goals can be based in whole or part on next-higher CMS Stars rating levels, as defined for the various CMS measures in the selected CMS domains.

The measure summary panel can be used to select particular CMS measures, and a measure detail panel or module can be provided to display performance gaps for the selected CMS measures. The measure detail panel can also be configured to receive initial or user selected goals for closing the performance gaps. A modeling processor can be provided in communicative coupling with the user interface, and configured for forecasting and updating the domain-level CMS Stars ratings associated with the selected contract, based on the user selected goals.

The measure detail panel can also display achievable goals to close the performance gaps, where the achievable goals are based on performance improvement benchmarks defined by historical data for selected insurance contracts. The selected insurance contracts may be top performing Medicare Advantage insurance contracts, for example top first or second quartile CMS Stars rated contracts. The benchmarks can also be defined by historical performance for the contract of interest (that is, the contract selected for modeling). Alternatively, benchmark contracts may be selected based on similarity of member populations, for example based on one or more of age distribution, geographical range, health conditions, or other population measure.

While this invention has been described with reference to exemplary embodiments, it will be understood by those skilled in the art that various changes can be made and equivalents may be substituted, without departing from the spirit and scope of the invention. In addition, modifications may be made to adapt the teachings of the invention to particular situations and materials, without departing from the essential scope thereof. Thus, the invention is not limited to the particular examples that are disclosed herein, but encompasses all embodiments falling within the scope of the appended claims.

1. A computer implemented method for managing CMS (Centers for Medicare and Medicaid Services) Stars program data, the method comprising:
storing historical CMS raw scores and historical CMS Stars ratings in a database, the database in communication with a computer system having a user interface;
updating the database with CMS Stars ratings data for an insurance program; and
via the computer system:
calculating CMS raw scores for the insurance program, based on the updated CMS Stars rating data;
modeling CMS Stars ratings for the insurance program, based on the calculated CMS raw scores; and
outputting the modeled CMS Stars ratings to the user interface.

2. The method of claim 1, further comprising generating historical CMS trends and CMS year-to-date data for the insurance program, based on the historical CMS raw scores and the updated CMS Stars ratings data.

3. The method of claim 2, further comprising:
forecasting CMS Stars ratings for the insurance program via the computer system, based on the historical CMS trends and the CMS year-to-date data; and
outputting the forecast CMS Stars ratings to the user interface.

4. The method of claim 1, further comprising:
determining performance gaps via the computer system, based on differences between the modeled CMS Stars ratings and user-defined goals for the ratings; and
outputting the performance gaps to the user interface.

5. The method of claim 4, further comprising assigning accountable owners to CMS measures corresponding to the CMS raw scores, via input received from the user interface.

6. The method of claim 5, further comprising assigning initiatives to the accountable owners via input received from the user interface, wherein the initiatives describe user actions to close the performance gaps via contact with a healthcare provider or member of the insurance program.

7. The method of claim 6, further comprising assigning status updates to the accountable owners via input received from the user interface, wherein the status updates describe status of the initiatives.

8. The method of claim 1, further comprising generating an achievable goal for at least one of the modeled CMS Stars ratings, wherein the achievable goal is based on benchmark performance improvements stored in the database.

9. The method of claim 8, wherein the benchmark performance improvements represent historical performance of selected insurance plans for a given CMS measure corresponding to the achievable goal.

10. The method of claim 9, wherein the selected insurance plans comprise a top quartile of insurance plans for the given CMS measure.

11. The method of claim 1, further comprising:
receiving an initial user selected goal related to a prior year CMS Stars rating for a selected CMS measure, via the user interface; and
updating the modeled CMS Stars ratings for the selected measure via the computer processing system, based on the user selected goal.

12. The method of claim 11, further comprising updating the modeled CMS Stars ratings at a measure domain level corresponding to the selected measure via the computer processing system, based on the user selected goal.

13. The method of claim 12, further comprising updating the modeled CMS Stars ratings at a contract or part level corresponding to the selected measure via the computer processing system, based on the user selected goal.

14. The method of claim 11, wherein the user selected goal comprises a target value for the selected CMS measure.

15. The method of claim 11, wherein the user selected goal comprises a target value for one of the modeled CMS Stars ratings corresponding to the selected CMS measure.

16. The method of claim 1, wherein modeling the CMS Stars ratings comprises modeling current values for the CMS Stars ratings based on the calculated CMS raw scores, and further comprising:
forecasting future values for the CMS Stars ratings, based on the historical CMS raw scores and the updated CMS Stars ratings data; and
determining performance gaps for the CMS Stars ratings, based on differences between the modeled current values and the forecast future values.

17. The method of claim 16, further comprising:
rank ordering the CMS Stars ratings with the computer system, based on the performance gaps; and
outputting the modeled current values of the CMS Stars ratings for display on the user interface, in the rank ordering.

18. The method of claim 17, wherein the performance gaps describe care gaps based on a difference between care provided to members of the insurance program and goals for the care provided to the members of the insurance program.

19. A CMS (Centers for Medicare and Medicaid Services) Stars program data management system comprising:
a database comprising memory configured for storing historical CMS raw scores, historical CMS Stars ratings, and updated CMS data for an insurance program;
a computer system in communicative coupling with the database, the computer system configured to calculate CMS raw scores based on the updated CMS data, and to forecast CMS Stars ratings for the insurance program based on the calculated CMS raw scores; and
a user interface configured to output the forecast CMS Stars ratings to a user.

20. The system of claim 19, further comprising a model processor configured to forecast the CMS measures at a future date, based on the historical CMS raw scores and the updated CMS data.

21. The system of claim 20, wherein the updated CMS data comprise year-to-date raw scores for CMS measures corresponding to the CMS Stars ratings.

22. The system of claim 20, further comprising a model processor configured to determine performance gaps for the calculated CMS raw scores, based on differences between the calculated CMS raw scores and seasonally-adjusted target CMS raw scores.

23. The system of claim 22, wherein the user interface is configured to display the forecast CMS Stars ratings in a rank order based on performance goals for the CMS Stars ratings.

24. The system of claim 22, wherein the rank order is further based on a weighted variance or variation of the goals.

25. The system of claim 22, wherein the model processor is further configured to output an initiative to the user interface, wherein the initiative describes a user action to close one of the performance gaps via contact with a healthcare provider or member of the insurance program.

26. The system of claim 22, wherein the performance goals are selected based on achievable improvements for CMS measures corresponding to the CMS Stars ratings, and wherein the achievable improvements have been achieved by a top quartile of insurance programs for the corresponding CMS measures.

27. The system of claim 19, wherein the user interface is configured to receive a target value for a CMS measure corresponding to one of the forecast CMS Stars ratings, and wherein the computer system is configured to update the forecast CMS Stars ratings at domain and insurance plan levels based on the target value.

28. A user interface for computer-based data management of CMS (Centers for Medicare and Medicaid Services) Stars rating program data, the interface comprising:
a contract summary panel configured for selecting a health care contract;
a domain summary panel configured for displaying and selecting domain-level CMS Stars ratings associated with the selected contract; and
a measure summary panel configured for displaying CMS measures for CMS domains selected from the domain summary panel.

29. The user interface of claim 28, wherein the contract summary panel is further configured to select a time period and a Medicare Part C or Part D option for the health care contract.

30. The user interface of claim 28, wherein the domain-level CMS Stars ratings are rank ordered in the domain summary panel, based on a performance gap between calculated values of the domain-level CMS Stars ratings and goals for the domain-level CMS Stars ratings.

31. The user interface of claim 30, wherein the goals for the domain-level CMS Stars ratings are based at least in part by next-higher CMS Stars rating levels defined for the CMS measures in the selected CMS domains.

32. The user interface of claim 28, wherein the measure summary panel is configured to select the CMS measures and further comprising a measure detail panel configured to display performance gaps for the selected CMS measures.

33. The user interface of claim 32, wherein the measure detail panel is configured to receive user selected goals for closing the performance gaps.

34. The user interface of claim 33, further comprising a modeling processor configured for forecasting and updating the domain-level CMS Stars ratings associated with the selected contract, based on the user selected goals.

35. The user interface of claim 32, wherein the measure detail panel is configured to display achievable goals to close the performance gaps, the achievable goals based on performance improvement benchmarks defined by historical data for selected insurance contracts.

36. The user interface of claim 35, wherein the selected insurance contracts comprise top quartile performing Medicare Advantage insurance contracts.

37. The user interface of claim 28, wherein the measure summary panel is configured to display trending data for the CMS measures, the trending data based on actual historical and forecast values for the CMS measures.

38. The user interface of claim 37, wherein the measure summary panel is further configured to display performance goals for the CMS measures, along with the trending data.

39. The user interface of claim 28, wherein the forecast values of the CMS measures are seasonally adjusted based on historical compliance data for the CMS measures.

40. The user interface of claim 39, wherein the forecast values of the CMS measures comprise seasonally adjusted goals based on the historical compliance data.
